(19) United States
(12) Patent Application Publication
(10) Pub. No.: US 2004/0004969 A1
(43) Pub. Date: Jan. 8, 2004

(54) Interconnecting device, interconnecting method, computer readable medium and communication system

(75) Inventor: Takayuki Ohta, Tokyo (JP)

Correspondence Address: RYUKA, 1-24-12 SHINJUKU, SIXTH FLOOR, TOSHIN BUILDING, SHINJUKU-KU, TOKYO, 160-0022, JP

(73) Assignee: ALLIED TELESIS K.K., Tokyo (JP)

(21) Appl. No.: 10/064,947

(22) Filed: Sep. 2, 2002

(30) Foreign Application Priority Data
Jul. 5, 2002 (WO) PCT/JP02/06871

(51) Int. Cl. H04L 12/56

(52) U.S. Cl. 370/402

(57) ABSTRACT

An interconnecting device which interconnects a plurality of Internet Service Providers (ISP) and user terminals including a routing information acquisition unit which acquires routing information between a communication terminal which the user terminal accesses through either of the plurality of ISPs, and each of the plurality of ISPs, a destination information storing unit which stores terminal identification information of a communication terminal and ISP identification information of either of the plurality of ISPs in association with the terminal identification information, based on the routing information acquired by the routing information acquisition unit, a receiving unit which receives packets from the user terminal, a terminal identification information acquisition unit which acquires terminal identification information of a destination communication terminal from the packet received by the receiving unit, and a transmitting unit which transmits the packets to the ISP which associates with the terminal identification information which is acquired by the terminal identification information acquisition unit, and stored in the destination information storing unit.

### CROSS REFERENCE TO RELATED APPLICATIONS

This patent application claims priority from a PCT application No. PCT/JP02/06871 filed on Jul. 5, 2002, the contents of which are incorporated herein by reference.

### BACKGROUND OF INVENTION

1. Field of the Invention

The present invention relates to an interconnecting device, an interconnecting method, a computer readable medium and a communication system. More particularly, the present invention pertains to an interconnecting device that interconnects a plurality of Internet Service Providers (ISP) and user terminals.

2. Description of the Related Art

Realization of high speed lines which deliver a lot of data, such as music, image data, video data, etc. through the Internet is expected with the popularization of the Internet use in recent years. In response to such demand, broadband lines such as asymmetric digital subscriber line (ADSL) or fiber to the home (FTTH) has become widespread in office buildings, hotels, apartment houses, etc.

In the ADSL or the FTTH, a user terminal connects to an ISP using point to point protocol over Ethernet (PPPoE) by a router or the like, and connects to the Internet through the ISP. Recently, there has been developed a router which establishes a plurality of PPPoE sessions to a plurality of ISPs using one physical circuit.

Such a router is demanded to switch the PPPoE sessions dynamically by usual operation of a user, without making a user conscious of the plurality of PPPoE sessions, in order to get the most out of the plurality of established PPPoE sessions.

### SUMMARY OF INVENTION

Therefore, it is an object of the present invention to provide an interconnecting device, an interconnecting method, a program and a communication system, which are capable of satisfying the foregoing demand. The object can be achieved by combinations described in the independent claims. The dependent claims define further advantageous and exemplary combinations of the present invention.

In order to attain such an object, according to a first aspect of the present invention, there is provided an interconnecting device which interconnects a plurality of ISPs and user terminals. The interconnecting device includes a receiving unit which receives packets from the user terminals, a destination information acquisition unit which acquires a destination IP address from the packet received by the receiving unit, a domain name acquisition unit which acquires a domain name, corresponding to the destination IP address acquired by the destination information acquisition unit, from a DNS server, a destination information storing unit which stores the domain name and the ISP identification information in association with the domain name, and a transmitting unit which transmits the packets to the ISP, ISP identification information of which is stored in the destination information storing unit in association with the domain name acquired by the domain name acquisition unit.

According to a second aspect of the present invention, there is provided an interconnecting device which interconnects a plurality of ISPs and user terminals. The interconnecting device includes a routing information acquisition unit which acquires routing information between a communication terminal, which the user terminal accesses through either of the plurality of ISPs, and each of the plurality of ISPs, a destination information storing unit which stores terminal identification information of a communication terminal and either of the plurality of ISP identification information in association with the terminal identification information, based on the routing information acquired by the routing information acquisition unit, a receiving unit which receives packets from the user terminal, a terminal identification information acquisition unit which acquires terminal identification information of the destination communication terminal from the packet received by the receiving unit, and a transmitting unit which transmits the packets to the ISP, ISP identification information of which is stored in the destination information storing unit in association with the terminal identification information acquired by the terminal identification information acquisition unit.

The routing information acquisition unit may acquire routing information between the communication terminal identified by a domain name, and each of the plurality of ISPs. The destination information storing unit may store the domain name and either of the plurality of ISP identification information in association with the domain name, based on the routing information acquired by the routing information acquisition unit. The terminal information acquisition unit may acquire a destination IP address from the packets received by the receiving unit, and acquire a domain name corresponding to the acquired destination IP address from a DNS server. The transmitting unit may transmit the packets to the ISP, identification information of which is stored in the destination information storing unit in association with the domain name acquired by the terminal information acquisition unit.

The routing information acquisition unit may acquire hop counts, as the routing information, at the time of transmitting packets to a communication terminal identified by the domain name through each of the plurality of ISPs. The destination information storing unit may store the domain name and the ISP identification information in association with the domain name, when the hop count via the ISP, acquired by the routing information acquisition unit, is fewer than the hop count via the other ISPs.

The routing information acquisition unit may acquire response times, as the routing information, at the time of transmitting packets to a communication terminal identified by the domain name through each of the plurality of ISPs. The destination information storing unit may store the domain name and the ISP identification information in association with the domain name, when the response time via the ISP, acquired by the routing information acquisition unit, is shorter than the response time via the other ISPs.

The transmitting unit may continue, until predetermined period passes, to transmit the packets received by the receiving unit from the user terminal to the same ISP after the transmitting unit begins to transmit the packet to the ISP, identification information of which is stored in the destination information storing unit in association with the domain name acquired by the terminal information acquisition unit.

The interconnecting device may further include a historical information storing unit which stores the routing information acquired by the routing information acquisition unit in association with a time. The destination information storing unit may store the domain name and either of the plurality of ISP identification information in association with the domain name and each time zone based on the routing information stored in the historical information storing unit.

The interconnecting device may further include an access count storing unit which stores an access count to the communication terminal identified by the domain name in association with the domain name. The routing information acquisition unit may acquire routing information between the communication terminal identified by a domain name, and each of the plurality of ISPs, in the case where the access count stored in the access count storing unit is more than a predetermined count.

According to a third aspect of the present invention, there is provided an interconnecting method for an interconnecting device which interconnects a plurality of ISPs and user terminals. The interconnecting method includes a receiving step which receives packets from the user terminals, a destination information acquisition step which acquires a destination IP address from the packet received in the receiving step, a domain name acquisition step which acquires a domain name corresponding the destination IP address acquired in the destination information acquisition step from a DNS server, and a transmitting step which transmits the packets to the ISP, identification information of which is stored in the destination information storing unit in association with the domain name acquired in the domain name acquisition step.

According to a fourth aspect of the present invention, there is provided an interconnecting method for an interconnecting device which interconnects a plurality of ISPs and user terminals. The interconnecting method includes a routing information acquisition step which acquires routing information between a communication terminal which the user terminal accesses through either of the plurality of ISPs, and each of the plurality of ISPs, a destination information storing step which stores the destination information storing unit with terminal identification information of a communication terminal and either of the plurality of ISP identification information in association with the terminal identification information, based on the routing information acquired in the routing information acquisition step, a receiving step which receives packets from the user terminal, a terminal identification information acquisition step which acquires terminal identification information of a destination communication terminal from the packet received in the receiving step, and a transmitting step which transmits the packets to the ISP, identification information of which is stored in the destination information storing unit in association with the terminal identification information acquired in the terminal identification information acquisition step.

According to a fifth aspect of the present invention, there is provided a program for an interconnecting device which interconnects a plurality of ISPs and user terminals. The program operates the interconnecting device by a receiving means which receives packets from the user terminals, a destination information acquisition means which acquires a destination IP address from the packet received by the receiving means, a domain name acquisition means which acquires a domain name corresponding to the destination IP address acquired by the destination information acquisition means from a DNS server, a destination information storing means which stores the domain name and the ISP identification information in association with the domain name, and a transmitting means which transmits the packets to the ISP, identification information of which is stored in the destination information storing unit in association with the domain name acquired by the domain name acquisition means.

According to a sixth aspect of the present invention, there is provided a program for an interconnecting device which interconnects a plurality of ISPs and user terminals. The program operates the interconnecting device by a routing information acquisition means which acquires routing information between a communication terminal which the user terminal accesses through either of the plurality of ISPs, and each of the plurality of ISPs, a destination information storing means which stores terminal identification information of a communication terminal and either of the plurality of ISP identification information in association with the terminal identification information, based on the routing information acquired by the routing information acquisition means, a receiving means which receives packets from the user terminal, a terminal identification information acquisition means which acquires terminal identification information of a destination communication terminal from the packet received by the receiving means, and a transmitting means which transmits the packets to the ISP, identification information of which is stored in the destination information storing means in association with the terminal identification information acquired by the terminal identification information acquisition means.

According to a seventh aspect of the present invention, a communication system is provided. The communication system includes an interconnecting device which interconnects user terminals and the Internet, and a plurality of ISPs which authenticate the interconnecting device and permit connection with the Internet. The interconnecting device includes a receiving unit which receives packets from the user terminals, a destination information acquisition unit which acquires a destination IP address from the packet received by the receiving unit, a domain name acquisition unit which acquires a domain name, corresponding to the destination IP address acquired by the destination information acquisition unit, from a DNS server, a destination information storing unit which stores the domain name and the ISP identification information in association with the domain name, and a transmitting unit which transmits the packets to the ISP, ISP identification information of which is stored in the destination information storing unit in association with the domain name acquired by the domain name acquisition unit.

According to an eighth aspect of the present invention, a communication system is provided. The communication system includes an interconnecting device which interconnects user terminals and the Internet, and a plurality of ISPs which authenticate the interconnecting device and permit connection with the Internet. The interconnecting device includes a routing information acquisition unit which acquires routing information between a communication terminal, which the user terminal accesses through either of the plurality of ISPs, and each of the plurality of ISPs, a destination information storing unit which stores terminal identification information of a communication terminal and either of the plurality of ISP identification information in association with the terminal identification information, based on the routing information acquired by the routing information acquisition unit, a receiving unit which receives packets from the user terminal, a terminal identification information acquisition unit which acquires terminal identification information of the destination communication terminal from the packet received by the receiving unit, and a transmitting unit which transmits the packets to the ISP, ISP identification information of which is stored in the destination information storing unit in association with the terminal identification information acquired by the terminal identification information acquisition unit.

This summary of invention does not necessarily describe all necessary features so that the invention may also be a sub-combination of these described features.

### BRIEF DESCRIPTION OF DRAWINGS

FIG. 1 shows an example of a configuration of a communication system 10 according to an embodiment of the present invention.

FIG. 2 shows an example of a functional configuration of a router 100 of the present embodiment.

FIG. 3 shows an example of a data format of an access count storing unit 116 of the present embodiment.

FIG. 4 shows an example of a data format of an historical information storing unit 114 of the present embodiment.

FIG. 5 shows an example of a data format of a destination information storing unit 110 of the present embodiment.

FIG. 6 shows an example of a sequential function flow of an ISP selection method of the router 100 of the present embodiment.

FIG. 7 shows an example of a sequential function flow of a packet interconnecting method of the router 100 of the present embodiment.

FIG. 8 shows an example of a hardware configuration of a user terminal 300a of the present embodiment.

### DETAILED DESCRIPTION

The invention will now be described based on the embodiments hereinafter, which do not intend to limit the scope of the present invention as defined in the appended claims. All of the features and the combinations thereof described in the are not necessarily essential to the invention.

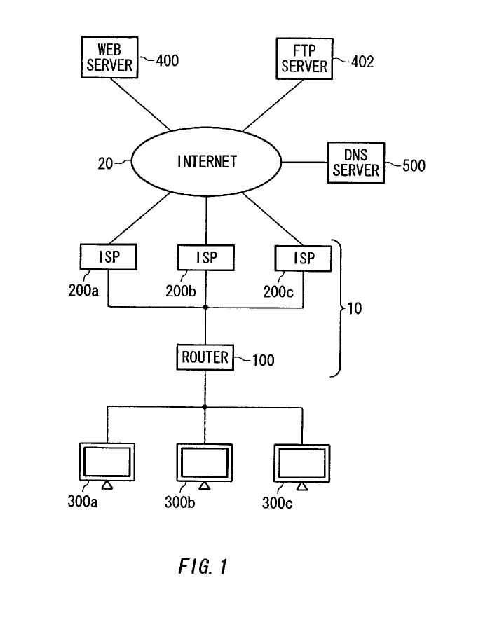

FIG. 1 shows an example of a configuration of a communication system 10 according to an embodiment of the present invention. The communication system 10 includes a router 100, an example of an interconnecting device, which interconnects user terminals 300a, 300b and 300c and the Internet 20. The communication system 10 also includes a plurality of ISPs 200a, 200b and 200c which authenticate the router 100 and permit to access the Internet 20.

The router 100 establishes sessions to each of the plurality of ISPs, for example, by PPPoE. Then the router 100 receives packets received from the user terminals 300b and 300c and selects one of the ISPs 200a, 200b and 200c based on a destination of the received packets. Then the router 100 transmits the received packets to the Internet 20 through the selected ISP.

For example, the router 100 stores terminal identification information which identifies a Web server 400 in association with ISP identification information of the ISP 200a, stores terminal identification information which identifies a FTP server 402 in association with the ISP 200b, and stores terminal identification information which identifies a DNS server 500 in association with the ISP 200c. In this case, the router 100 transmits the packets addressed to the Web server 400, received from the user terminals 300a, 300b and 300c, through the ISP 200a, transmits the packets addressed to the FTP server 402 through the ISP 200b, and transmits the packets addressed to the DNS server 500 through the ISP 200c.

According to the communication system 10 of the present embodiment, since the router 100 switches the ISP to be relayed dynamically by usual operation by users of the user terminals 300a, 300b and 300c, without making them conscious of a plurality of sessions being established, the plurality of sessions are effectively exploited.

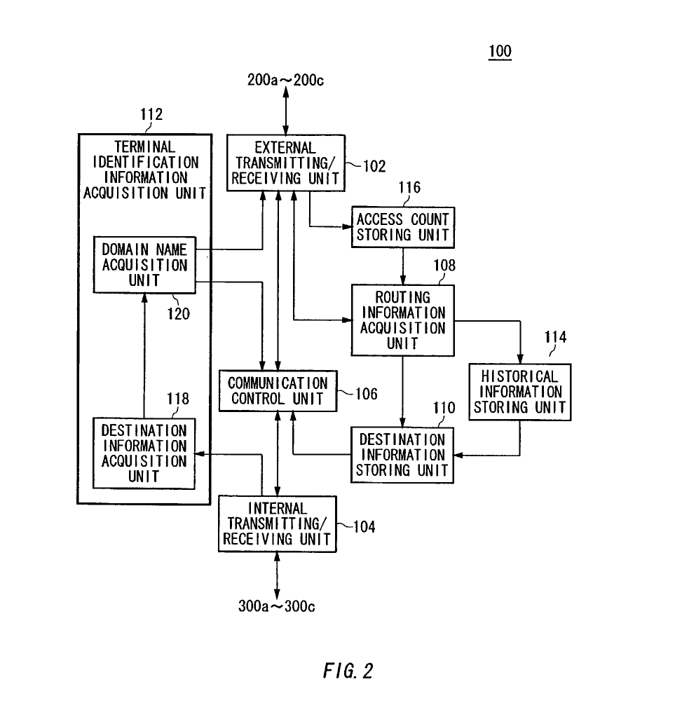

FIG. 2 shows an example of a functional configuration of the router 100 of the present embodiment.

The router 100 includes an external transmitting/receiving unit 102, an internal transmitting/receiving unit 104, a communication control unit 106, a routing information acquisition unit 108, a destination information storing unit 110, and a terminal identification information acquisition unit 112. The external transmitting/receiving unit 102 connects to the ISPs 200a, 200b and 200C and transmits and receives packets to/from the ISPs 200a, 200b and 200C. The internal transmitting/receiving unit 104 connects to the user terminals 300a, 300b and 300c and transmits and receives packets to/from the user terminals 300a, 300b and 300c. The communication control unit 106 controls communication between the external transmitting/receiving unit 102 and the internal transmitting/receiving unit 104. The routing information acquisition unit 108 acquires routing information between a communication terminal such as the Web server 400, the FTP server 402 or the DNS server 500, which the user terminals 300a, 300b and 300c access through either of the ISPs 200a, 200b or 200c, and each of the ISP 200a, 200b and 200c. The destination information storing unit 110 stores terminal identification information which identify a communication terminal and ISP identification information of either of the ISP 200a, 200b or 200c in association with the terminal identification information, based on the routing information acquired by the routing information acquisition unit 108. The terminal identification information acquisition unit 112 acquires terminal identification information of the destination communication terminals from the packets received from the user terminals 300a, 300b and 300c by the internal transmitting/receiving unit 104. The external transmitting/receiving unit 102 transmits the packets, received from the user terminals 300a, 300b and 300c by the internal transmitting/receiving unit 104, to the ISP, identification information of which is stored in the destination information storing unit 110 in association with the terminal identification information acquired by the terminal identification information acquisition unit 112.

The terminal identification information acquisition unit 112 includes a destination information acquisition unit 118 which acquires a destination IP address from the packets received from the user terminals 300a, 300b and 300c by the internal transmitting/receiving unit 104. The terminal identification information acquisition unit 112 also includes a domain name acquisition unit 120 which acquires a domain name corresponding to the destination IP address, acquired by the destination information acquisition unit 118, from the DNS server 500. The domain name acquisition unit 120 acquires the domain name corresponding to the destination IP address by transmitting a reverse DNS lookup request packet including the IP address acquired by the destination information acquisition unit 118, to the DNS server 500 through the external transmitting/receiving unit 102.

Moreover, the routing information acquisition unit 108 acquires routing information between a communication terminal identified by a domain name, an example of terminal identification information, and each of the ISPs 200a, 200b and 200c. Then the destination information storing unit 110 stores the domain name and ISP identification information of either of the ISPs 200a, 200b or 200c in association with the domain name, based on the routing information acquired by the routing information acquisition unit 108. The external transmitting/receiving unit 102 transmits the packets, received from the user terminals 300a, 300b and 300c by the internal transmitting/receiving unit 104, to the ISP, identification information of which is stored in the destination information storing unit 110 in association with the domain name acquired by the domain name acquisition unit 120.

Specifically, the routing information acquisition unit 108 transmits packets to a communication terminal identified by a predetermined domain name through each of the ISP 200a, 200b and 200c. Then the routing information acquisition unit 108 acquires hop counts between the communication terminal identified by the predetermined domain name and the router 100, and response times from the communication terminal identified by the predetermined domain name, as routing information, about cases where each of the ISPs 200a, 200b and 200c is relayed. Then the destination information storing unit 110 stores the predetermined domain name and the ISP identification information in association with the predetermined domain name, in the case where, for example, the hop count via the ISP, acquired by the routing information acquisition unit 108, is fewer than the hop count via the other ISPs. The destination information storing unit 110 also stores the predetermined domain name and the ISP identification information in association with the predetermined domain name, in the case where, for example, the response time via the ISP, acquired by the routing information acquisition unit 108, is shorter than the response time via the other ISPs.

That is, the routing information acquisition unit 108 transmits Ping packets to the Web server 400, for example, through each of the ISPs 200a, 200b and 200c. Then the routing information acquisition unit 108 receives reply packets of the transmitted Ping packets from the Web server 400 and acquires hop counts and response times. Then the routing information acquisition unit 108 selects an ISP, from the ISP 200a, 200b and 200c, through which the shortest path to the Web server 400 is established, based on the hop counts or the response times of the reply packets through each of ISPs 200a, 200b and 200c. Then the destination information storing unit 10 stores therein the domain name, which is the terminal identification information of the Web server 400, and the ISP identification information in association with the domain name, through which the shortest path to the Web server 400 is established. The router 100 further includes a historical information storing unit 114 which stores routing information acquired by the routing information acquisition unit 108 in association with a time. The destination information storing unit 110 may store a domain name and ISP identification information of either of the ISPs 200a, 200b or 200c in association with the domain name and each time zone, based on the routing information stored in the historical information storing unit 114.

Moreover, the router 100 further includes an access count storing unit 116 which stores an access count to the communication terminal identified by the domain name in association with a domain name. The routing information acquisition unit 108 may acquire routing information between a communication terminal identified by the domain name, and each of the ISPs 200a, 200b and 200C, in the case where an access count stored in the access count storing unit 116 is more than a predetermined count. Then the destination information storing unit 110 may store the domain name and ISP identification information of either of ISPs 200a, 200b or 200C in association with the domain name, in the case where the access count is more than the predetermined count.

According to the router 100 of the present embodiment, the ISP to be relayed is switched according to a destination of the packets received from the user terminals 300a, 300b and 300c in order that the hop count or the response time is minimized. Therefore, the user terminals 300a, 300b and 300c acquire information from the Web server 400 or the FTP server 402 on the Internet 20 quickly, and a user browse information on the Web server 400 or the FTP server 402 comfortably.

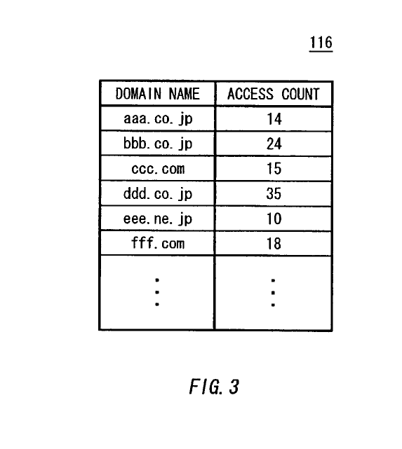

FIG. 3 shows an example of a data format of an access count storing unit 116 of the present embodiment.

The access count storing unit 116 stores a domain name which identifies a communication terminal on the Internet 20, and an access count during a predetermined period to the communication terminal identified by the domain name.

For example, the access count storing unit 116 counts an access count, within one week or one day, from the user terminals 300a, 300b and 300c to the communication terminal identified by the domain name. The routing information acquisition unit 108 acquires routing information between the communication terminal identified by the domain name, and each of the ISPs 200a, 200b and 200c based on these access counts. For example, the routing information acquisition unit 108 acquires the routing information between the communication terminal, identified by the domain name, and each of ISPs 200a, 200b and 200c, in the case where the access count to the communication terminal is more than ten times. Then the destination information storing unit 110 stores the domain name and ISP identification information of the either of ISP 200a, 200b or 200c in association with the domain name based on the routing information acquired by the routing information acquisition unit 108.

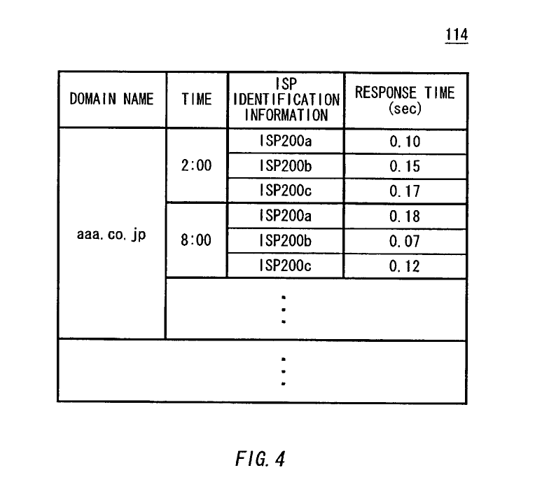

FIG. 4 shows an example of a data format of an historical information storing unit 114 of the present embodiment.

The historical information storing unit 114 stores a domain name which identifies a communication terminal on the Internet 20, a time when the routing information acquisition unit 108 acquires the routing information, ISP identification information which identifies the ISP 200a, 200b and 200c, and a response time as an example of the routing information, all of which is associated with each other.

For example, the routing information acquisition unit 108 transmits Ping packets to a communication terminal identified by a domain name “aaa.cojp” through each of ISPs 200a, 200b and 200c at time “2:00”, to acquire response times. The routing information acquisition unit 108 also transmits Ping packets to the communication terminal identified by the domain name “aaa.cojp” through each of ISPs 200a, 200b or 200 and 200C at time “8:00”, to acquire response times.

Then, as shown in FIG. 4, the historical information storing unit 114 stores the response time acquired by the routing information acquisition unit 108 in association with a time and each of the ISPs 200a, 200b, and 200c. Specifically, the response time through the ISP 200a is the shortest at time “2:00”, and the response time through the ISP 200b is the shortest at time “8:00”. Then the destination information storing unit 110 stores the domain name and ISP identification information of either of the ISPs 200a, 200b or 200c in association with the domain name and each time zones, based on the response time at each times.

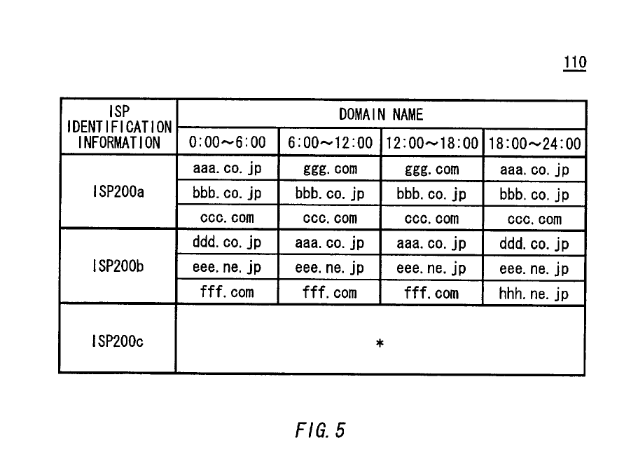

FIG. 5 shows an example of a data format of a destination information storing unit 110 of the present embodiment.

The destination information storing unit 110 stores a domain name which identifies the communication terminal on the Internet 20 and ISP identification information which identifies the ISPs 200a, 200b and 200c in association with the domain name and each time zone. Moreover, the destination information storing unit 110 may further store an IP address which identifies the communication terminal on the Internet 20 in association with the ISP identification information.

The destination information storing unit 110 stores the ISP identification information of the ISP through which the response time or the hop count to the communication terminal, identified by the domain name, is minimized in each time zone. For example, as shown in FIG. 4, the response time to a communication terminal identified by a domain name “aaa.cojp” through the ISP 200a at time “2:00” is the shortest, and the response time through the ISP 200b at time “8:00” is the shortest. Accordingly, as shown in FIG. 5, the destination information storing unit 110 stores the domain name “aaa.cojp” in association with the ISP 200a in a time zone “0:00-6:00”, and in association with the ISP 200b in a time zone “6:00-12:00”.

Moreover, a mark “*”, which is stored in the destination information storing unit 110 in association with the ISP 200c, is a wildcard, and the external transmitting/receiving unit 102 transmits packets to a communication terminal, identified by a domain name other than the domain name stored in association with the ISP 200a and 200b, through the ISP 200c.

According to the router 100 of the present embodiment, since the destination information storing unit 110 stores the domain name which identifies the communication terminal which is accessed frequently and ISP identification information of either of ISPs 200a, 200b or 200c in association with the domain name, the ISP, through which the hop count or the response time become minimum, is selected when accessing the frequently accessed communication terminal.

Moreover, according to the router 100 of the present embodiment, since the destination information storing unit 110 stores the domain name and ISP identification information of either of the ISP 200a, 200b or 200c in association with the domain name and each time zone, the ISP to be relayed is selected in order that the hop count or the response time through the ISP become minimum, based on a time zone to access the communication terminal.

Moreover, according to the router 100 of the present embodiment, since the destination information storing unit 110 stores the domain name, the ISP is selected appropriately even if the IP address of the communication terminal is changed.

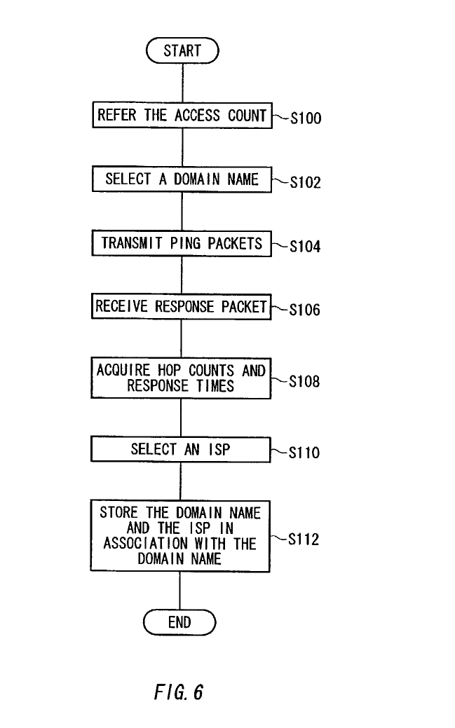

FIG. 6 shows an example of a sequential function flow of an ISP selection method of the router 100 of the present embodiment.

The routing information acquisition unit 108 refers the access count stored in the access count storing unit 116 (S100), and selects a domain name of a communication terminal, access count of which is more than a predetermined count (S102). The routing information acquisition unit 108 may select a domain name of a communication terminal with higher access count ranking than other communication terminals. The routing information acquisition unit 108 may select a domain name arbitrarily.

Next, the routing information acquisition unit 108 transmits Ping packets to the communication terminal identified by the selected domain name through each of the ISP 200a, 200b and 200c (S104). Then the routing information acquisition unit 108 receives response packets of the transmitted Ping packets from the communication terminal (S106), and acquires hop counts and response times through each of the ISP 200a, 200b and 200c (S108).

Then the routing information acquisition unit 108 selects either of the ISPs 200a, 200b or 200c to be relayed, based on the acquired hop counts and the response times, when accessing the communication terminal identified by the domain name selected in S102 (S110). Then the destination information storing unit 110 stores the domain name which is selected by the routing information acquisition unit 108 and the ISP identification information in association with the domain name (S112). The sequential function flow of the ISP selection method is ended hereinbefore.

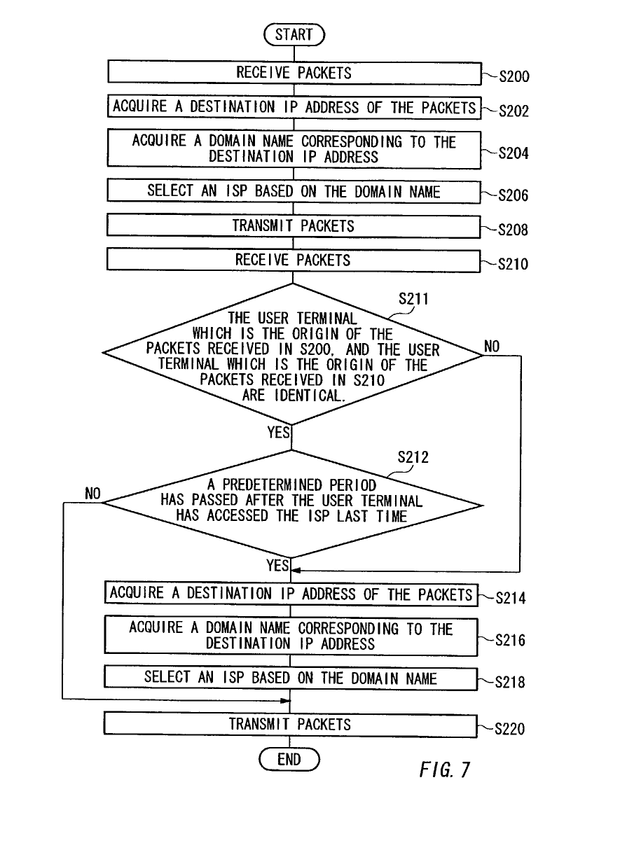

FIG. 7 shows an example of a sequential function flow of a packet interconnecting method of the router 100 of the present embodiment.

The internal transmitting/receiving unit 104 receives the packets to be transmitted to the Internet 20 from either of the user terminal 300a, 300b or 300c (S200). Then the destination information acquisition unit 118 acquires a destination IP address from the packet received at the internal transmitting/receiving unit 104 in S200 (S202). Then the domain name acquisition unit 120 acquires a domain name corresponding to the destination IP address by transmitting a reverse DNS lookup request packet, including the destination IP address acquired by the destination information acquisition unit 118, to the DNS server 500 through the external transmitting/receiving unit 102 (S204).

Then the communication control unit 106 selects an ISP, identification information of which is stored in the destination information storing unit 110 in association with a domain name acquired by the domain name acquisition unit 120 (S206). Then the external transmitting/receiving unit 102 transmits the packets received by the internal transmitting/receiving unit 104 in S200 through the ISP selected by the communication control unit 106 in S206 based on control of the communication control unit 106 (S208).

Furthermore, the internal transmitting/receiving unit 104 receives the packets to be transmitted to the Internet 20 from either of the user terminals 300a, 300b or (S210). Then, the communication control unit 106 decides whether the user terminal which is the origin of the packets received by the internal transmitting/receiving unit 104 in S200, and the user terminal which is the origin of the packets received in S210, are identical (S211).

In S211, if the communication control unit 106 decides that the user terminal which is the origin of the packets received by the internal transmitting/receiving unit 104 in S200, and the user terminal which is the origin of the packets received in S210, are not identical, the packets, received by the internal transmitting/receiving unit 104 in S210, are transmitted through the ISP selected by the communication control unit 106 in S218 by the same sequential flow as S202-S208 (S214-S220).

In S211, if the communication control unit 106 decides that the user terminal which is the origin of the packets received by the internal transmitting/receiving unit 104 in S200, and the user terminal which is the origin of the packets received in S210 are identical, the communication control unit 106 decides whether a predetermined period has passed, after the user terminal has accessed the ISP last time (S212).

In S212, if the communication control unit 106 decides that the predetermined period has passed after the user terminal has accessed the ISP last time, the packets, received in S210 by the internal transmitting/receiving unit 104, are transmitted through the ISP selected by the communication control unit 106 in S210 by the same sequential flow as S202-S208 (S214-5220).

In S212, if the communication control unit 106 decides that the predetermined period has not passed after the user terminal has accessed the ISP last time, the packets, received in S210 by the internal transmitting/receiving unit 104, are transmitted through the ISP selected by the communication control unit 106 in S206 (S220). The sequential function flow of the packet interconnecting method is ended hereinbefore.

That is, according to the router 100 of the present embodiment, the external transmitting/receiving unit 102 continues to transmit the packets, received from the same user terminal by the internal transmitting/receiving unit 104, to the same ISP until a predetermined period passes after it begins to transmit the packets to the ISP, identification information of which is stored in the destination information storing unit 110 in association with the domain name acquired by the domain name acquisition unit 120. Therefore, by adjusting the predetermined period during which the same user terminal connects the same ISP, a frequency of selection operation of the ISPs by the router 100 is adjusted moderately, and delay of routing by the router 100 during the selection operation of the ISPs is reduced.

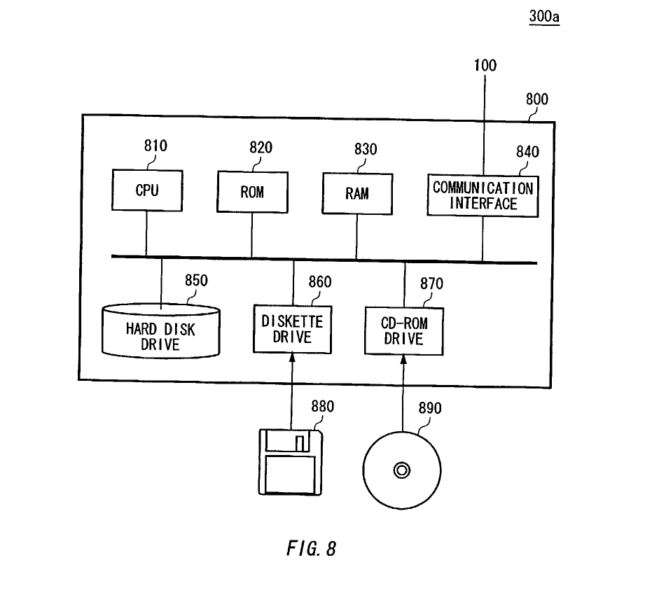

FIG. 8 shows an example of a hardware configuration of a user terminal 300a of the present embodiment.

A function of the user terminal 300a is realized by cooperation of a CPU 810, a ROM 820, a RAM 830, a communication interface 840, and a computer 800 with a hard disk drive 850, and a program executed on the computer 800. The computer 800 may further include a diskette drive 860 and/or a CD-ROM drive 870.

The communication interface 840 communicates with the router 100 through a computer network, and provides the router 100 with a program stored in a diskette 880, a CD-ROM 890 or the like.

The program which operates the router 100 includes an external transmitting/receiving module, an internal transmitting/receiving module, a communication controlling module, a routing information acquisition module, a destination information storing module, a terminal identification information acquisition module, a historical information storing module, an access count storing module, a destination information acquisition module and a domain name acquisition module. These modules are programs which enable the computer 800 to function as the external transmitting/receiving unit 102, the internal transmitting/receiving unit 104, the communication control unit 106, the routing information acquisition unit 108, the destination information storing unit 110, the terminal identification information acquisition unit 112, the historical information storing unit 114, the access count storing unit 116, the destination information acquisition unit 118 and the domain name acquisition unit 120.

The programs or modules shown above may be stored on an optical recording medium, such as a DVD or a PD, a magneto-optical recording medium such as a Minidisk, a tape medium or a semiconductor memory such as an IC card. Moreover, a storage unit such as a hard disk or a RAM in a server system on a dedicated communication network or the Internet may be used as a recording medium, and the programs may be provided to the router 100 through a foreign network or a network which connects to the computer 800.

Although the present invention has been described by way of exemplary embodiment, the scope of the present invention is not limited to the foregoing embodiment. Various modifications in the foregoing embodiment may be made when the present invention defined in the appended claims is enforced. It is obvious from the definition of the appended claims that embodiments with such modifications also belong to the scope of the present invention.

1. An interconnecting device which interconnects a plurality of ISPs and user terminals comprising:
a receiving unit which receives packets from the user terminals,
a destination information acquisition unit connecting to said receiving unit,
which acquires a destination IP address from the packets received by said receiving unit,
a domain name acquisition unit which acquires a domain name, corresponding to the destination IP address acquired by said destination information acquisition unit,
a destination information storing unit which stores the domain name and ISP identification information of the ISP in association with the domain name; and
a transmitting unit connecting to said domain name acquisition unit and said destination information storing unit, said transmitting unit transmitting the packets to the ISP, ISP identification information of which is stored in said destination information storing unit in association with the domain name acquired by said domain name acquisition unit.

2. An interconnecting device which interconnects a plurality of ISPs and user terminals comprising:
a routing information acquisition unit which acquires routing information between a communication terminal which the user terminal accesses through either of the plurality of ISPs, and each of the plurality of ISPs,
a destination information storing unit which stores terminal identification information of a communication terminal and ISP identification information of either of the plurality of ISPs in association with the terminal identification information, based on the routing information acquired by said routing information acquisition unit,
a receiving unit which receives packets from the user terminal,
a terminal identification information acquisition unit which acquires terminal identification information of a destination communication terminal from the packet received by said receiving unit; and
a transmitting unit which transmits the packets to the ISP, ISP identification information of which is stored in said destination information storing unit in association with the terminal identification information acquired by said terminal identification information acquisition unit.

3. The interconnecting device as claimed in claim 2, wherein said routing information acquisition unit acquires routing information between the communication terminal identified by a domain name, and each of the plurality of ISPs, said destination information storing unit stores the domain names and ISP identification information of either of the plurality of ISPs in association with the domain name, based on the routing information acquired by said routing information acquisition unit, said terminal information acquisition unit acquires a destination IP address from the packets received by said receiving unit, and acquires a domain name corresponding to the acquired destination IP address from a DNS server, and said transmitting unit transmits the packets to the ISP, ISP identification information of which is stored in said destination information storing unit in association with the domain name acquired by said terminal information acquisition unit.

4. The interconnecting device as claimed in claim 3, wherein said routing information acquisition unit acquires hop counts, as the routing information, at the time of transmitting packets to a communication terminal identified by the domain name through each of the plurality of ISPs, and said destination information storing unit stores the domain name and the ISP identification information in association with the domain name, when the hop count via the ISP, acquired by said routing information acquisition unit, is fewer than the hop count via the other ISPs.

5. The interconnecting device as claimed in claim 3, wherein said routing information acquisition unit acquires response times, as the routing information, at the time of transmitting packets to a communication terminal identified by the domain name through each of the plurality of ISPs, and said destination information storing unit stores the domain name and the ISP identification information in association with the domain name, when the response time via the ISP, acquired by said routing information acquisition unit, is shorter than the response time via the other ISPs.

6. The interconnecting device as claimed in claim 3, wherein said transmitting unit continues, until predetermined period passes, to transmit packets received by said receiving unit from the user terminal to the same ISP, after said transmitting unit begins to transmit the packets to the ISP, ISP identification information of which is stored in said destination information storing unit in association with the domain name acquired by said terminal information acquisition unit.

7. The interconnecting device as claimed in claim 3, further comprising a historical information storing unit which stores the routing information acquired by said routing information acquisition unit in association with a time, wherein said destination information storing unit stores the domain name and ISP identification information of either of the plurality of ISPs in association with the domain name and each time zone, based on the routing information stored in said historical information storing unit.

8. The interconnecting device as claimed in claim 3, further comprising an access count storing unit which stores an access count to the communication terminal identified by the domain name in association with the domain name, wherein said routing information acquisition unit acquires routing information between the communication terminal identified by a domain name, and each of the plurality of ISPs, in the case where the access count stored in said access count storing unit is more than a predetermined count.

9. An interconnecting method of an interconnecting device which interconnects a plurality of ISPs and user terminals, comprising:
a receiving step which receives packets from the user terminals,
a destination information acquisition step which acquires a destination IP address from the packet received in said receiving step,
a domain name acquisition step which acquires a domain name corresponding to the destination IP address acquired in said destination information acquisition step from a DNS server; and
a transmitting step which transmits the packets to the ISP, ISP identification information of which is stored in said destination information storing unit in association with the domain name acquired in said domain name acquisition step.

10. An interconnecting method of an interconnecting device which interconnects a plurality of ISPs and user terminals, comprising:
a routing information acquisition step which acquires routing information between a communication terminal which the user terminal accesses through either of the plurality of ISPs, and each of the plurality of ISPs,
a destination information storing step which stores terminal identification information of a communication terminal and ISP identification information of either of the plurality of ISPs in association with the terminal identification information to said destination information storing unit, based on the routing information acquired in said routing information acquisition step,
a receiving step which receives packets from the user terminal,
a terminal identification information acquisition step which acquires terminal identification information of a destination communication terminal from the packet received in said receiving step; and
a transmitting unit which transmits packets to the ISP, ISP identification information of which is stored in said destination information storing unit in association with the terminal identification information acquired in said terminal identification information acquisition step.

11. A computer readable medium storing thereon a program for an interconnecting device which interconnects a plurality of ISPs and user terminals, operating the interconnecting device by:
a receiving means which receives packets from the user terminals,
a destination information acquisition means which acquires a destination IP address from the packet received by said receiving means,
a domain name acquisition means which acquires a domain name corresponding to the destination IP address acquired by said destination information acquisition means from a DNS server,
a destination information storing means which stores the domain name and the ISP in association with the domain name; and
a transmitting means which transmits the packets to the ISP, ISP identification information of which is stored in said destination information storing unit in association with the domain name acquired by said domain name acquisition means.

12. A computer readable medium storing thereon a program for an interconnecting device which interconnects a plurality of ISPs and user terminals, operating the interconnecting device by:
a routing information acquisition means which acquires routing information between a communication terminal which the user terminal accesses through either of the plurality of ISPs, and each of the plurality of ISPs,
a destination information storing means which stores terminal identification information of a communication terminal and ISP identification information of either of the plurality of ISPs in association with the terminal identification information, based on the routing information acquired by said routing information acquisition means,
a receiving means which receives packets from the user terminal,
a terminal identification information acquisition means which acquires terminal identification information of a destination communication terminal from the packet received by said receiving means; and
a transmitting means which transmits the packets to the ISP, ISP identification information of which is stored in said destination information storing unit in association with the terminal identification information acquired by said terminal identification information acquisition means.

13. A communication system comprising an interconnecting device which interconnects user terminals and the Internet, and a plurality of ISPs which authenticate the interconnecting device and permit connection with the Internet, the interconnecting device comprising:
a receiving unit which receives packets from the user terminals,
a destination information acquisition unit which acquires a destination IP address from the packets received by said receiving unit,
a domain name acquisition unit which acquires a domain name, corresponding to the IP address acquired by said destination information acquisition unit, from a DNS server,
a destination information storing unit which stores the domain name and the in association with the domain name,
a transmitting unit which transmits the packets to the ISP, ISP identification information of which is stored in said destination information storing unit in association with the domain name acquired by said domain name acquisition unit.

14. A communication system comprising an interconnecting device which interconnects user terminals and the Internet, and a plurality of ISPs which authenticate the interconnecting device and permit connection with the Internet, the interconnecting device comprising:
a routing information acquisition unit which acquires routing information between a communication terminal which the user terminal accesses through either of the plurality of ISPs, and each of the plurality of ISPs,
a destination information storing unit which stores terminal identification information of a communication terminal and ISP identification information of either of the plurality of ISPs in association with the terminal identification information, based on the routing information acquired by said routing information acquisition unit,
a receiving unit which receives packets from the user terminal,
a terminal identification information acquisition unit which acquires terminal identification information of a destination communication terminal from the packet received by said receiving unit; and
a transmitting unit which transmits the packets to the ISP, ISP identification information of which is stored in said destination information storing unit in association with the terminal identification information acquired by said terminal identification information acquisition unit.
